(19) United States
(12) Patent Application Publication
(10) Pub. No.: US 2015/0322339 A1
(43) Pub. Date: Nov. 12, 2015

(54) USE OF POLYAMINE AS ANTI-STICKING ADDITIVE

(71) Applicant: Herbert EGLI, Kunten (CH)

(72) Inventor: Herbert EGLI, Kunten (CH)

(73) Assignee: CONSTRUCTION RESEARCH & TECHNOLOGY GMBH, Trostberg (DE)

(21) Appl. No.: 14/238,366

(22) PCT Filed: Aug. 17, 2012
(86) PCT No.: PCT/EP2012/066059

§ 371 Date: May 22, 2014

(30) Foreign Application Priority Data
Aug. 22, 2011 (EP) 11178223.1

(51) Int. Cl. C09K 17/18; E02D 3/00; C09K 17/14

(52) U.S. Cl. CPC C09K 17/18; C09K 17/14; E02D 3/00

(57) ABSTRACT

Method of use of at least one polyamine compound as sticking decreasing additive for soil with a clay content of more than 10% by weight.

Subject of this invention is a method of use of at least one polyamine as sticking decreasing additive for clay containing soils.

It is prior art knowledge that polymeric additives in modest concentrations of less than 0.5% by mass are widely used in tunneling applications to treat the soils and thereby improving the mechanical properties of the excavated ground. The main function of the polymeric additives can be seen in controlling the water content of the excavated soil, acting as dispersing agent and preventing the day containing soils from dumping.

Since the mechanism of polymer adsorption and their resulting alteration of the soil mechanical properties of paste-like mixtures for the use in the earth pressure shield in tunnel boring machines is still not well understood there have been a lot of suggestions and proposals for new chemical developments regarding the additives and their polymeric characteristics.

There are existing test results regarding the use of the commercial polymer products “Rheosoil 211” and “Rheosoil 214” in smectite, kaolinite and illite containing soils. The efficiency of the commercial polymers could be shown for kaolinitic clays but not for illite and smectite containing days. In the publication of Moore and Mitchell (1974, Geotechnique, 24, 627-640) the effect of the dielectric properties of the pore-fluid on shear strength of clay has been studied and analytical techniques for expressing electrormagnetic forces of interaction in soils regarding kaolinite were described. It was concluded by the authors that pore-fluids with a dielectric constant in the range of clay dielectric constant can decrease the shear strength considerably.

For verifying the prior art results and for strengthening the properties of polymeric additives it was an object of this invention to find alternative anti-sticking additives for specific clay containing soils.

This problem could be solved by a new method of use of at least one polyamine compound. The polyamine can be selected par example from the group consisting of derivatives of diethylenetriamine, triethanolamine or combination thereof with adipicacid(polyamidoamine), polyamidoamines and polyamidoanmin quaterniert as sticking decreasing additive for soil with a clay content of more than 10% by weight.

By using the selected polyamines or mixtures thereof as anti-sticking additive it could be shown that aqueous systems containing clay show a higher shear strength whereas the residual strength of the tested clay systems stays unchanged.

This effect of the selected polyamines on the sheer strength of clay could not be expected from the results of Moore and Mitchell (1974; see above): From the results of these authors there has to be expected that the residual shear strength drops dramatically. However, by using polyamines the illite type clay have less stickiness and therefore shows a completely different effect. Additionally, the clear anti-sticking effect could be visualized over a broad range of water content by—for example—adding stepwise increasing amounts of water. An additional effect was to be observed in form of a visible reduction of stickiness on metal surfaces, porcelain and also skin if dry clay was mixed with a water/polyamine solution.

Surprisingly other polyamines showed a much more less influence on the shear strength of clay and especially illite containing systems. Polyamines selected form the group consisting of derivatives of diethylenetriamine, triethanoiamine or combination thereof with adipicacid(polyamidoamine), polyamidoamines and polyamidoamin quaterniert as sticking decreasing additive for soil with a clay content of more than 10% by weight as typical polyathylenamines and known as flocculant. In clay suspensions show a positive influence on the shear strength of illite.

Investigations show that clay mixtures containing illite, kaolinite, smectite and or Bodmer clay treated with triethanolamine derivatives do not stick to metal surfaces whereas the same mixtures treated with polyamidoamines or dietheylenetriamine+adipicacid(polyamidoamine) derivatives stick to metal surfaces with clay mixtures containing smectite.

The method according to the present invention shows its surprising effects preferably in soil systems containing at least one clay mineral representative selected from illite, Bodmer clay, kaolinite and/or smectite.

In a preferred alternative of the invention the polyamine is used at a concentration of from 0.5 to 2.0% by weight, and preferably of 1.0% by weight related to the clay content.

In a preferred embodiment of the invention the method characterized in that the clay is represented by at least one species selected from the group consisting of illite, Bodmer clay, kaolinite, and/or smectite.

In a preferred embodiment of the invention the method characterized in, that the polyamine is used in combination with polycarboxylates based dispersants.

In a further embodiment of the invention the method characterized in, that the dispersants have anti-sticking properties over clay.

In a further embodiment of the invention the method characterized in, that the polyamine and/or the dispersant is/are used in liquid form, and preferably as one combined liquid additive.

In a preferred embodiment of the invention the method characterized in, that the liquid additive is applied to the clay containing soil in amounts of from 0.5 to 2.0% by weight and preferring of 0.0% by weight of the clay content.

A further preferred embodiment the method characterized in, that triethanolamine derivates are used in the case that the clay is represented mainly by illite, Bodmer clay, kaolinite and/or smectite.

A further preferred embodiment the method characterized in that polyamidomines or diethylenetriamine+adipicacid(polyamidoamine) derivatives are used in the case that the day is represented mainly by illite, kaolinite and/or Bodmer clay.

A further preferred embodiment the method characterized in that the polyamine is used during tunnel excavation.

It is also possible to use the polyamine or mixtures thereof in combination with polycarxboxyiates based dispersants whereby the dispersants can also show anti-sticking properties towards a day.

Derivatives of diethylenetriamine, triethanolamine or combination thereof with adipicacid(polyamidoamine) and polyamidoamines and all the dispersant can according to the present invention be used in liquid form and/or preferably as one combined liquid additive.

The present invention comprises as additional preferred alternative the application of the liquid additive to the clay containing soil in amounts of from 0.5 to 2.0% by weight and preferring of 1.0% by weight related to the clay content.

Because of its surprising features in decreasing the stickiness the polyamine is used according to the present invention preferably during tunnel excavation.

Surprisingly it could be shown by the new method that triethanolamine derivatives have advantageous in soils containing illite, Bodmer clay, kaolinite, and/or smectite, and polyamidomines or diethylenetriamine+adipicacid(polyamidoamine) derivatives in soils mainly containing illite, kaolinite and/or Bodmer clay.

The economic advantage by using these amine derivatives during driving a tunnel with a tunnel boring machine in EPB (earth pressure balance) modus are the reduction of stick down the cutter head. From this it follows that faster advanced rate are possible and less maintenance time is needed.

The examples show the surprising advantages of selected polyamines as sticking decreasing additive.

The following examples illustrate this invention

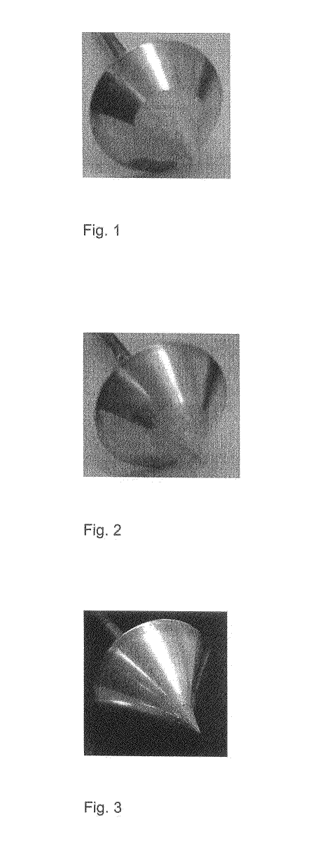

FIG. 1-11 show the results of stickiness measurements of adherence of anti-sticking agents with clay type illite, Bodmer clay, kaolinite and/or smectite with no anti-sticking additive or with Rheosoil 211 or triethanolamine derivatives or polyamidoamines or polyamidoamin quaterniert or diethylenetriamine+adipicacid(polyamidoamine) derivatives.

### EXAMPLE 1

### Measurements Adherence of Clay Type Illite

500 clay type illite and 450 g water with or without 5 g Rheosoil 211 or triethanolamine derivatives or polyamidoamin quarterniert or diethylenetriamine+adipicacid(polyamidoamine) derivatives are mixed in a mixing vessel with a mortar mixer until a homogeneous paste is obtained. The paste is transferred into a cup (ASTM 0217-02) until a smooth surface is obtained, it may not include air bubbles in the cup. The cup is placed under the cons and conus and the conus is adjusted until the cone end is in contact with the surface of the paste. Measuring the penetration according to the manual of the Penetrmmeter PNR 10 (penetration time 5 seconds). The penetration is measured in millimeter.

After the measurement of the penetration the conus is gently removed from the clay/water sample and the adherence of clay/water sample to the surface of the conus is photographed and judged. The stickiness (adherence) is classified as following:

Adherence

| no surface | Low surface | medium surface | high surface |
|---|---|---|---|
| coverage | coverage | coverage | coverage |
| <5% | 5-25% | 25-75% | >75% |

FIG. 1 shows the adherence of anti-sticking agents with clay type illite with no anti-sticking additive or with Rheosoil 211 with a high surface coverage (90%).

FIG. 2 shows the adherence of anti-sticking agents with clay type illite with anti-sticking additive triethanolamine derivatives (GV 34261/L1897) with a medium surface coverage (50%).

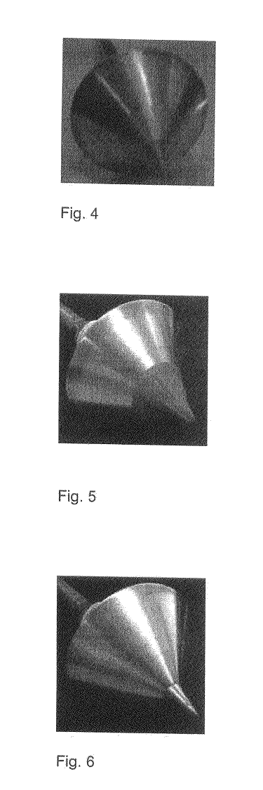

FIG. 3 shows the adherence of anti-sticking agents with clay illite with anti-sticking additive polyamidoamin quarterniert or triethanolamine derivatives (GV 35005/19) or diethylenetriamine+adipicacid(polyamidoamine) derivatives (B 2407/05, B 2874/08 B 2875/08, B 2876/08) with a low surface coverage (15%).

FIG. 4 shows the adherence of anti-sticking agents with clay type illite with anti-sticking additive triethanolamine derivatives (GV 35005/18) with a low surface coverage (5%).

### EXAMPLE 2

### Measurements Adherence of Clay Type Bodmer

360 g clay type Bodmer and 200 g water with or without 5 g triethanolamine derivatives or polyamidoamin quarterniert or diethylenetriamine+adipicacid(polyamidoamine) derivatives are mixed in a mixing vessel with a mortar mixer until a homogeneous paste is obtained. The paste is transferred into a cup (ASTM D217-02) until a smooth surface is obtained. It may not include air bubbles in the cup. The cup is placed under the conus and the conus is adjusted until the cone end is in contact with the surface of the paste. Measuring the penetration according to the manual of the Penetrometer PNR 10 (penetration time 5 seconds). The penetration is measured in millimeter.

After the measurement of the penetration the conus is gently removed from the clay/water sample and the adherence of clay/water sample to the surface of the conus is photographed and judged. The stickiness (adherence) is classified as following:

Adherence

| no surface | Low surface | Medium surface | high surface |
|---|---|---|---|
| coverage | coverage | coverage | coverage |
| <5% | 5-25% | 25-75% | >75% |

FIG. 5 shows the adherence of anti-sticking agents with clay type Bodmer with no anti-sticking additive with a high surface coverage (90%).

FIG. 6 shows the adherence of anti-sticking agents with clay type Bodmer with anti-sticking additive polyamidoamin quarterniert or triethanolamine derivatives (GV 35005/18, GV 35005/19, GV 34621/L1697) or diethylenetriamine+adipicacid(polyamidoamine) derivatives (B 2407/05, B 2874/08, B 2875/08, B 2876/08) with a low surface coverage (5%).

### EXAMPLE 3

### Measurements Adherence of Clay Type Kaolinite

500 g clay type kaolinite and 289 g water with or without 5 g triethanolamine derivatives or polyamidoamin quarterniert or diethyenetriamine+adipicacid(polyamidoamine) derivatives are mixed in a mixing vessel with a mortar mixer until a homogeneous paste is obtained. The paste is transferred into a cup (ASTM D217-02) until a smooth surface is obtained. It may not include air bubbles in the cup. The cup is placed under the conus and the conus is adjusted until the cone end is in contact with the surface of the paste. Measuring the penetration according to the manual of the Penetrometer PNR 10 (penetration time 5 seconds). The penetration is measured in millimeter.

After the measurement of the penetration the conus is gently removed from the clay water sample and the adherence of clay/water sample to the surface of the conus is photographed and judged. The stickiness (adherence) is classified as following:

Adherence

| no surface | Low surface | medium surface | high surface |
|---|---|---|---|
| coverage | coverage | coverage | coverage |
| <5% | 5-25% | 25-75% | >75% |

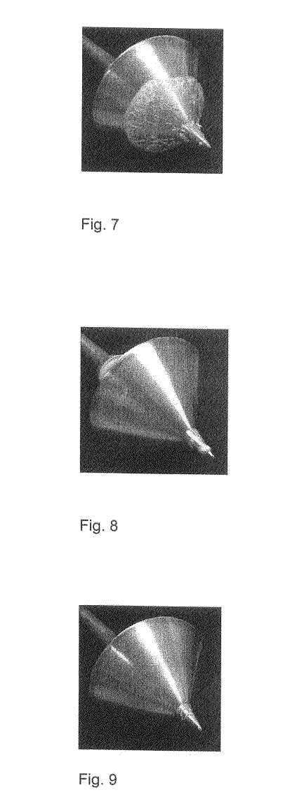

FIG. 7 shows the adherence of anti-sticking agents with clay type kaolinite with no anti-sticking additive or with anti-sticking additive polyamidoamin quarterniert with a medium surface coverage (50%).

FIG. 8 shows the adherence of anti-sticking agents with clay type kaolinite with anti-sticking additive triethanolamine derivatives (GV 3500518, GV 34261/L1697) or diethylenetriamine+adipicacid(polyamidoamine) derivatives (B 2407/05, B 2875/08) with a low surface coverage (15%).

FIG. 9 shows the adherence of anti-sticking agents with clay type kaolinite with anti-sticking additive triethanolamine derivatives (GV 35005/19 or diethylenetriamine+adipicacid(polyamidoamine) derivatives with a low surface coverage (5%).

### EXAMPLE 4

### Measurements Adherence of Clay Type Smectite

500 g clay type smectite and 450 g water with or without 5 g triethanolamine derivatives or polyamidoamin quarterniert or diethylenetriamine+adipicacid(polyamidoamine) derivatives are mixed in a mixing vessel with a mortar mixer until a homogeneous paste is obtained. The paste is transferred into a cup (ASTM D217-02) until a smooth surface is obtained. It may not include air bubbles in the cup. The cup is placed under the conus and the conus is adjusted until the cone end is in contact with the surface of the paste. Measuring the penetration according to the manual of the Penetrometer PNR 10 (penetration time 5 seconds). The penetration is measured in millimeter.

After the measurement of the penetration the conus is gently removed from the clay/water sample and the adherence of clay/water sample to the surface of the conus is photographed and judged. The stickiness (adherence) is classified as following:

Adherence

| No surface | low surface | medium surface | high surface |
|---|---|---|---|
| coverage | coverage | coverage | coverage |
| <5% | 5-25% | 25-75% | >75% |

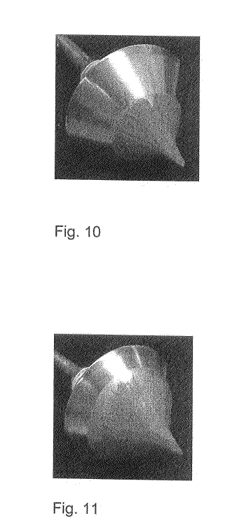

FIG. 10 shows the adherence of anti-sticking agents with clay type smectite with no anti-sticking additive or with anti-sticking additive polyamidoamin quarterniert, triethanolamine derivatives (GV 35005/18, GV 34261/L 1897) or diethylenetriamine+adipicacid(polyamidoamine) derivatives (B 2407/05, B 2874/08, B 2875/08, B 2876/08) with a high surface coverage (90%).

FIG. 11 shows the adherence of anti-sticking agents with clay type smectite with anti-sticking additive triethanolamine derivatives (GV 35005/19) with a medium surface coverage (50%).

Overview Adherence of Anti-Sticking Agents with Different Clay Types

Table 1 shows adherence of anti-sticking agents with clay type illite (%) (adherence surface coverage)

TABLE 1

| | |
|---|---|
| no anti-sticking additive | 87.5 |
| or RHEOSOIL 211 | 87.5 |
| or triethanolamine derivatives (GV 34261/L1697) | 50.0 |
| or polyamidoamin quarterniert | 15.0 |
| or triethanolamine derivatives (GV 35005/18) | 5.0 |
| or diethylenetriamine + adipicacid (polyamidoamine) | 15.0 |
| derivatives) (GV 35005/19) | |
| or diethylenetriamine + adipicacid (polyamidoamine) | 15.0 |
| derivatives) (B 2407/05) | |
| or diethylenetriamine + adipicacid (polyamidoamine) | 15.0 |
| derivatives) (B 2874/08) | |
| or diethylenetriamine + adipicacid (polyamidoamine) | 15.0 |
| derivatives) (B 2875/08) | |
| or diethylenetriamine + adipicacid (polyamidoamine) | 15.0 |
| derivatives) (B 2876/08) | |

Table 2 shows adherence of anti-sticking agents with Bodmer clay (%) (adherence surface coverage)

TABLE 2

| | |
|---|---|
| no anti-sticking additive | 87.5 |
| or polyamidoamin quarterniert | 2.5 |
| or triethanolamine derivatives (GV 34261/L1697) | 2.5 |
| or triethanolamine derivatives (GV 35005/18) | 2.5 |
| or triethanolamine derivatives (GV 35005/19) | 2.5 |
| or diethylenetriamine + adipicacid (polyamidoamine) | 2.5 |
| derivatives (B 2407/05) | |
| or diethylenetriamine + adipicacid (polyamidoamine) | 2.5 |
| derivatives (B 2874/08) | |
| or diethylenetriamine + adipicacid (polyamidoamine) | 2.5 |
| derivatives (B 2875/08) | |
| or diethylenetriamine + adipicacid (polyamidoamine) | 2.5 |
| derivatives (B 2876/08) | |

Table 3 shows adherence of anti-sticking agents with clay type kaolinite (%) (adherence surface coverage)

TABLE 3

| | |
|---|---|
| no anti-sticking additive | 50.0 |
| or Polyamidoamin quarterniert | 50.0 |
| or triethanolamine derivatives (GV 34261/L1697) | 15.0 |
| or triethanolamine derivatives (GV 35005/18) | 15.0 |
| or triethanolamine derivatives (GV 35005/19) | 2.5 |
| or diethylenetriamine + adipicacid | 15.0 |
| (polyamidoamine derivatives (B 2407/05) | |
| or diethylenetriamine + adipicacid | 2.5 |
| (polyamidoamine derivatives (B 2874/08) | |
| or diethylenetriamine + adipicacid | 15.0 |
| (polyamidoamine derivatives (B 2875/08) | |
| or diethylenetriamine + adipicacid | 2.5 |
| (polyamidoamine derivatives (B 2876/08) | |

Table 4 shows Adherence of anti-sticking agents with clay type smectite (%) adherence surface coverage)

TABLE 4

| | |
|---|---|
| no anti-sticking additive | 87.5 |
| or Polyamidoamin quarterniert | 87.5 |
| or triethanolamine derivatives (GV 34261/L1697) | 87.5 |
| or triethanolamine derivatives (GV 35005/18) | 87.5 |
| or triethanolamine derivatives (GV 35005/19) | 50.0 |
| or diethylenetriamine + adipicacid | 87.5 |
| (polyamidoamine derivatives (B 2407/05) | |
| or diethylenetriamine + adipicacid | 87.5 |
| (polyamidoamine derivatives (B 2874/08) | |
| or diethylenetriamine + adipicacid | 87.5 |
| (polyamidoamine derivatives (B 2875/08) | |
| or diethylenetriamine + adipicacid | 87.5 |
| (polyamidoamine derivatives (B 2876/08) | |

The results are shown in FIG. 1-11. It is shown that triethanolamine derivatives have advantageous in soils containing illite, Bodmer clay, kaolinite and/or smectite and polyamidomines or diethylenetriamine+adipicacid(polyamidoamine) derivatives in soils mainly containing illite, kaolinite and/or Bodmer clay.

1. Method of use of at least one polyamine compound as sticking decreasing additive for soil with a clay content of more than 10% by weight.

2. The method according to claim 1, characterized in, that the polyamine is used at a concentration of from 0.5 to 2.0% by weight of the clay content.

3. The method according to claim 1, characterized in, that the clay is represented by at least one species selected from the group consisting of illite, Bodmer clay, kaolinite, and/or smectite.

4. The method according to claim 1, characterized in, that the polyamine is used in combination with polycarboxylates based dispersants.

5. The method according claim 4, characterized in, that the dispersants have anti-sticking properties over clay.

6. The method according to claim 4, characterized in, that the polyamine and/or the dispersant is/are used in liquid form.

7. (canceled)

8. The method according to claim 1, characterized in, that triethanolamine derivates are used in the case that the clay is represented mainly by illite, Bodmer clay, kaolinite and/or smectite

9. The method according to claim 1, characterized in, that polyamidomines or diethylenetriamine+adipicacid (polyamidoamine) derivatives are used in the case that the clay is represented mainly by illite, kaolinite and/or Bodmer clay.

10. The method according to claim 1, characterized in, that the polyamine is used during tunnel excavation.

11. The method according to claim 4, characterized in, that the polyamine and the dispersant are used in liquid form as one combined liquid additive.

12. The method according to claim 11, characterized in, that the liquid additive is applied to the clay containing soil in amounts of from 0.5 to 2.0% by weight of the clay content.

13. The method according to claim 11, characterized in, that the liquid additive is applied to the clay containing soil in an amount of 1.0% by weight of the clay content.

14. The method according to claim 1, characterized in, that the polyamine is used at a concentration of 1.0% by weight of the clay content.
